(19) United States
(12) Patent Application Publication
(10) Pub. No.: US 2003/0176998 A1
(43) Pub. Date: Sep. 18, 2003

(54) Highly declarative end user specification, execution and explanation of master-detail applications of relational databases

(76) Inventor: Adrian Walker, Bristol, CT (US)

Correspondence Address: ADRIAN WALKER, REENGINEERING LLC, PO BOX 1412, BRISTOL, CT, 06011, US

(21) Appl. No.: 10/039,534

(22) Filed: Dec. 31, 2001

(51) Int. Cl. G06F 17/27

(52) U.S. Cl. 704/9

(57) ABSTRACT

A method and system are described for highly declarative specification of master-detail applications of relational databases, by end users who need not be trained in programming or in database administration. The method and system includes a notation in which end users can specify applications using their own English words and phrases, and by using place holders that are set out on indented lines to specify a master-detail hierarchy. The invention improves on the prior art by allowing a wider range of applications to be specified without programming, and without work by database administrators. The invention also improves on the prior art by automatically generating explanations showing what parts of the specification, and what supporting facts from the database, have been used in obtaining an answer to a question.

### BACKGROUND OF THE INVENTION

This invention relates to a method and apparatus for allowing an end user to specify and execute master-detail applications of relational databases. Relational databases are well known in the prior art, and, to be of use, they typically require the services of technically trained Database Administrators (DBAs), of application programmers, and of graphical user interface (GUI) designers. The specification of what an application should do is typically underdetermined to start with, and typically changes over time. The format of the underlying database tables also changes with time—for example, a new column is added to a table. These changes place considerable demand on the DBAs and application programmers, so that there is often a backlog of requests. Therefore, there is considerable interest in software to reduce the costs and improve the accuracy and maintainability of such changes. The prior art generally does this by software designed to move some, but not all, of the work of the DBA and of the application programmer to a notation or GUI that allows non-technical end users to do a certain amount of tailoring of an application. However, the prior art generally restricts the amount of such tailoring, typically to an intermediate database schema designed by a DBA, and to a set of applications that may not make use of iterative program loops or recursive subroutine calls. Thus, in the prior art, the price for moving some tailorability to the end user consists of restrictions on what the database application can be made to do.

A feature of relational databases is that they are in so-called “first normal form”. This means that an entry in a table cannot be regarded as compounded of subentries. On the other hand, many applications of databases concern real world objects or situations that have a natural hierarchical, or master-detail, structure. For example, a car may have a front and a rear axle, and each axle may have constant velocity joints, wheels, and so on. So, there is a class of application programs that take entries from the database and build compound data structures that can be used to create hierarchical GUI displays. Continuing with the car example, such a display can be shown using indentation to indicate the master-detail structure like this:

Car

Front Axle

Left CV Joint
Right CV Joint

Rear Axle

Left Rear Wheel
Right Rear Wheel.

In U.S. Pat. No. 5,701,453, Maloney et al describe how a DBA can prepare a logical schema that will allow an end user to do a certain amount of tailoring of an application that extracts a hierarchy of this kind from relational database tables. However, the application range available to the end user appears to be more limited than could reasonably be requested from application programmers.

Each of the other systems in the known prior art restricts the application range, and requires the services of a DBA to set up and maintain a mapping from an end user view to the actual tables in a database. To cover a complete range of the possible applications of a database, each of the systems in the known prior art also requires the services of application programmers. Moreover, in the known prior art, it is not possible for an end user to get an explanation of how the work of the DBA, of the application programmer, and any tailoring by some end user resulted in the extraction of a particular master-detail hierarchy from the database. The present invention, on the other hand, allows an end user to specify a wider range of applications, to execute the specifications of the applications, and to get automatically generated explanations of master-detail answers to questions put to the system.

### REFERENCES CITED

Maloney et al, “Logical schema to allow access to a relational database without using knowledge of the database structure”, U.S. Pat. No. 5,701,453, 1993.

Walker, A., “Syllog: a knowledge-based data management system”, Report No. 34, Department of Computer Science, New York University, 1981.

Walker, A., M. McCord, J. Sowa and W. Wilson, “Knowledge Systems and Prolog: Developing Expert, Database, and Natural Language Systems”, second edition, Addison-Wesley, 1990.

Walker, A., “Backchain Iteration: Towards a Practical Inference Method that is Simple Enough to be Proved Terminating, Sound and Complete”, Journal of Automated Reasoning, 11:1-22, 1993.

### SUMMARY OF THE INVENTION

To overcome the limitations in the prior art described above, and to overcome other limitations that will become apparent upon reading and understanding the present specification, the present invention discloses a method, system, apparatus, and article of manufacture for a computer implemented program that supports highly declarative end user specification, execution, and explanation of master-detail applications of relational databases.

Most current programming languages, such as C and Java, require the application programmer to spell out, step by step, what the computer must do to achieve a desired result. On the other hand, the specification of an application generally describes what must be done, rather than all of the details of how to do it. So a C programmer must read in the specification what has to be done, then he must design and write a program that describes in detail how to do it. Therein lies much of the cost of software development and maintenance.

Therefore, there is growing interest in programming languages at a higher level than C or Java, closer to the level of a specification. Such languages, including SQL and Prolog, are said to be more declarative than C or Java, which are said by contrast to be procedural. However, declarative languages such as SQL and Prolog are still intended mainly for use by DBAs and programmers, not by end users.

To further close the costly gap between a specification of a task and its implementation in software, the present invention describes a language at a higher declarative level than Prolog, in which an end user can specify an application using his own words and phrases in English-like sentences. In particular, using the language, end users can specify a wide range of master-detail and other applications over databases, and can run the specifications as though they were programs. One object of the present invention is the form of the highly declarative language. Another object of the present invention is the method used to process collections of statements in the language. A further object of the present invention is a method to automatically compute an explanation of a master-detail result from a database and a collection of statements in the language. Although end users are free to change their specifications over a wide range of possibilities, the present invention makes explanations of the results of running the specifications available automatically on request, with no need for separate maintenance. The present invention also describes how such a language processing and explanation capability can be implemented, using a logical programming language such as Prolog, as fixed component that does not change when the application changes. The highly declarative specification language used in the present invention is an extension, for producing master-detail results, of the language Syllog described in Walker 1981 and in Walker et al 1990. In the language Syllog, an executable specification consists of tables and syllogisms. A table in Syllog corresponds to a table in a relational database, written with a heading containing place holders corresponding to the column names embedded in an English sentence. For example, the following Syllog table

| this-item has a part | this-subitem |
|---|---|
| Car | Front Axle |
| Car | Rear Axle |
| Front Axle | Right CV Joint |
| Front Axle | Left CV Joint |
| Rear Axle | Right Rear Wheel |
| Rear Axle | Left Rear Wheel |

describes some parts and subparts of a car. It corresponds to a table with column names such as item and subitem in a relational database. A syllogism in the original Syllog language consists of one or more premises, an underline, and a conclusion. Continuing our example, a syllogism that uses the above Syllog table can be written as

| some-item has a part | some-subitem |
|---|---|
| that-item has a level 1 component | that-subitem |

The syllogism allows the underlying system to deduce, from the first row in the table, that a Car has a level 1 component Front Axle; from the second row that a Car has a level 1 component Rear Axle and so on. This deduction step looks similar to a step in the Prolog language, but the underlying execution mechanism is actually very different, for reasons described in Walker 1993.

In the original Syllog system the answer to a question put to a collection of syllogisms and tables is always a table in first normal form. That is, the system cannot supply an answer in the form of a hierarchical data structure that can be displayed as master-detail information. The present invention extends the syllogism notation, and the underlying execution and explanation methods, to support the automatic generation and explanation of master-detail answers to questions, based on syllogisms that can be written by end users. To do this, the notation is extended to syllogisms in which the first conclusion line can be followed by one or more indented lines. The indented lines contain place holders for values to be extracted from the database. Continuing our Car example, one such extended syllogism is

| | | |
|---|---|---|
| some-item has a level | some-level1 component | some-subitem |
| that-subitem has a level | some-level2 component | some-sub-subitem |

the components of that-item include:

that-subitem

that-sub-subitem

The additional indented conclusion lines that-subitem and that-sub-subitem allow the underlying extended system of the present invention to compute data structures that can be automatically displayed to an end user, for example as

Car

Front Axle

Left CV Joint
Right CV Joint

Rear Axle

Left Rear Wheel
Right Rear Wheel.

The data structures can also be used to produce nested table displays in Web pages, such as the display shown in FIG. 2. In addition, an end user can select a line of a nested table display and ask for it to be explained. If the end user presses the radio button next to Right Rear Wheel in FIG. 2, the system of the present invention automatically computes an explanation of the key deduction steps need for that entry to follow logically from the above facts and syllogisms. One way of displaying the resulting explanation is shown in FIG. 3.

While the functionality of the present invention, as summarized above, looks simple at an end user level, the hidden, fixed execution methods for deduction and explanation are complex, since they must correctly execute all future collections of syllogisms that an end user may write. In particular, automatic cross binding of values assigned to the place holders in syllogisms, to ensure correct results when the syllogisms are executed, is an important object of the present invention.

### BRIEF DESCRIPTION OF THE SEVERAL VIEWS OF THE DRAWING

FIG. 1 is a block diagram of the hardware and software environment of a system according to the present invention.

FIG. 2 shows one way of automatically displaying a hierarchical master-detail result, according to the present invention, as a collection of nested tables.

FIG. 3 shows one way of explaining, at the end user level, the logical steps that are performed to get a chosen entry in a master-detail result, according to the present invention.

### DETAILED DESCRIPTION OF THE INVENTION

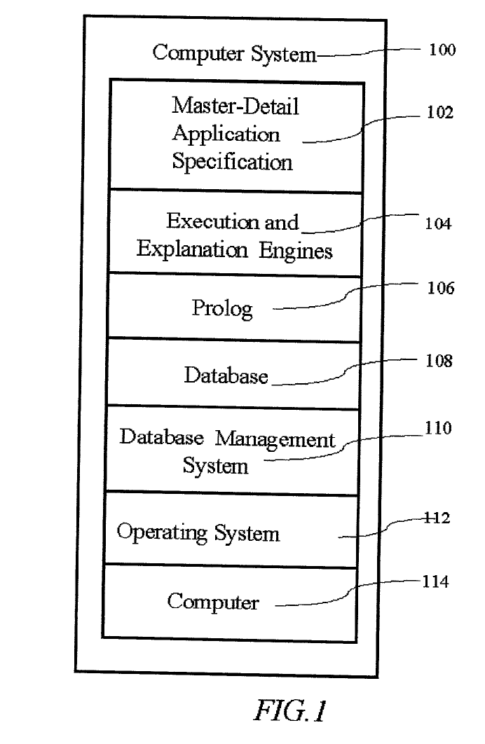

FIG. 1 is an exemplary hardware and software environment used to implement the preferred embodiment of the invention. The present invention is typically implemented using one or more computer systems 100, which can be connected by a network (not shown). A computer system 100 that implements the invention includes a hardware computer 114 and an operating system 112, (e.g., Unix). A computer system that implements the invention will also normally include a database management system 110 (e.g. Oracle, or DB2, or SQL server), and a database consisting of tables of facts 108. A preferred embodiment of the present invention includes software implementing the Prolog programming language 106 (e.g. Sicstus Prolog), that is used to program the fixed Execution and Explanation Engines 104. An end user, who need not have any database administration or application programming skills, can write a Master-Detail Application Specification 102, that can be executed by the Execution and Explanation Engines 104, which can optionally take their input and/or produce their output using XML, or HTML, or other tagged notation.

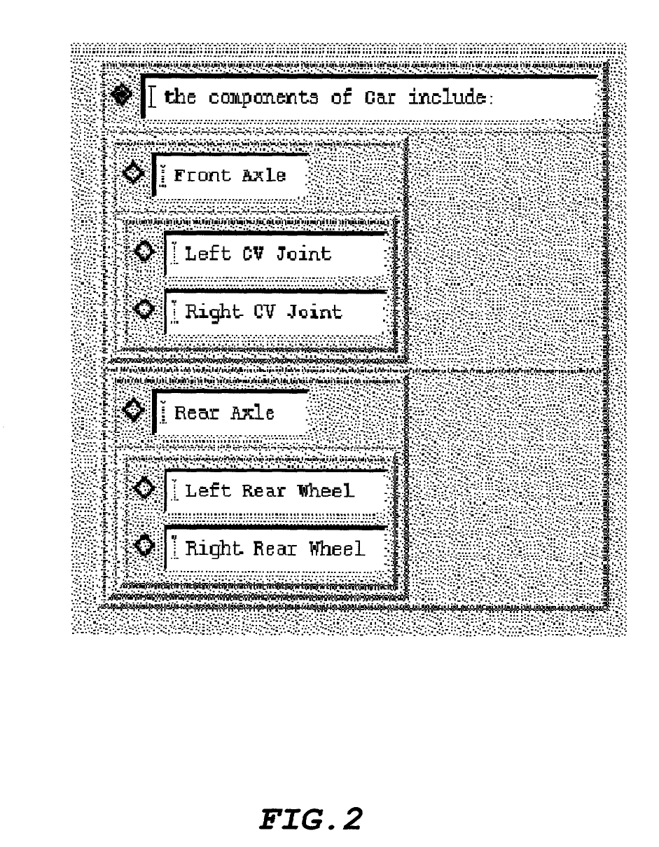

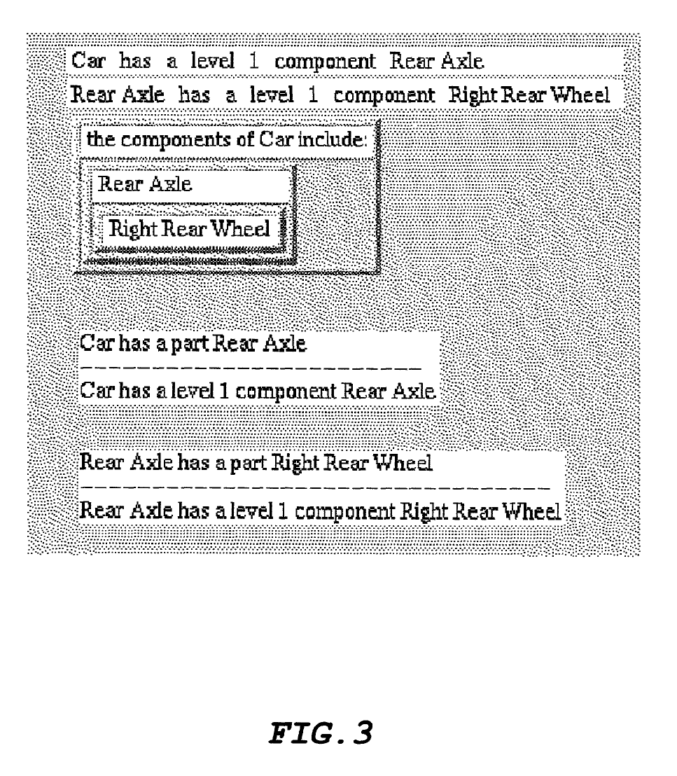

One skilled in the art will readily see how the components in FIG. 1 are used to realize various embodiments of the present invention as described herein and in FIGS. 2 and 3. The present invention may be implemented as a method, apparatus, or article of manufacture using standard programming and/or engineering techniques to produce software, firmware, hardware, or any combination thereof. The term “article of manufacture” (or alternatively, “computer program”) as used herein is intended to encompass a computer program accessible from any computer-readable device, carrier, or media. Of course, those skilled in the art will recognize that many modifications may be made to this configuration without departing from the scope of the present invention.

The preferred embodiment, described hereinafter and illustrated in FIGS. 1-3, represents the various subparts to the system of the present invention: compiler for master-detail syllogisms, execution engine method for processing for master-detail syllogisms, and explanation engine method for explaining results from master-detail syllogisms; each subpart will be discussed in detail hereinafter.

The preferred embodiment of the highly declarative end user specification, execution and explanation of master-detail applications of relational databases will be described using the logic programming notation, familiar to one skilled in the art, as the language Prolog. A syllogism written by an end user, such as

| some-item has a part | some-subitem |
|---|---|
| that-item has a level 1 component | that-subitem |

can be translated into Prolog notation as a rule p1(X, 1, Y) :-p2(X, Y), and can be executed in Prolog. However, there are syllogisms that an end user can write that can be written in Prolog notation, but that cannot be correctly executed by Prolog. One skilled in the art will recognize that a left recursive Prolog rule is one such example. In addition, the present invention includes master-detail syllogisms such as

| | | |
|---|---|---|
| some-item has a level | some-level1 component | some-subitem |
| that-subitem has a level | some-level2 component | some-sub-subitem |

the components of that-item include:

that-subitem

that-sub-subitem

that have no direct meaningful translations into ordinary Prolog rules. However, such a syllogism can be compiled into a data structure like this:

[t([p3(A),[],p1(A,B,C),p1(C,D,E)],

[t([[F],[],p1(G,H,F),p1(F,I,J)],

[t([[K],[F],p1(F,L,K)],[])])])]

In the data structure, p3(A) corresponds to the first conclusion line

the components of that-item include: of the master-detail syllogism, and the Prolog variable A corresponds to the place holder that-item. In the data structure, p1(A, B, C) corresponds to the first premise line

some-item has a level some-level1 component some-subitem of the master-detail syllogism, and the Prolog variables A, B, and C correspond to the place holders some-item, some-level1, and some-subitem, respectively.

In the second line of the data structure, the Prolog variable F corresponds to the place holder that-subitem in the second conclusion line of the syllogism. In the third line of the data structure, the Prolog variable K corresponds to the place holder that-sub-subitem in the last conclusion line of the syllogism. The Prolog variable F is present in both the second and third lines of the data structure, indicating the master-detail dependency of a sub-subitem on a subitem. It is this cross binding of values of F in the present invention that will prevent a wrong deduction such as that a Right Rear Wheel is a component of a Front Axle. More general patterns of cross binding can result from syllogisms written by end users.

Once a master-detail syllogism has been compiled into a data structure containing variables as indicated, it can be executed by the following general method of the present invention. The method also handles master-detail syllogisms in which the second and further conclusion lines can contain more than one place-holder.

Method Answer-Master-Detail-Question

INPUT: A master-detail Question in logical data structure notation of the general form [t([H, _|Bs], Ts)|T1s], where Ts and T1s may also be Questions.

OUTPUT: A master-detail Answer, of the same form as the input question. In the present invention, we use a method that defines a relation tdemo (Question, Answer). The method is as follows:

1. If the Question is an empty list, then the Answer is an empty list.

2. If the Question is of the form [t([H, _|Bs], [ ])], then the Answer is a list consisting of the non-empty set of instantiations of H such that demo (Bs), as in step 5 of this method, instantiates Bs. If the set is empty, this step fails, and the algorithm returns to the previous step.

3. If the Question is of the form [t([H, _Bs], [ ])|Xs], then

3.1 Find [t([H11, Bind1|B11s], T1s)=Xs

3.2 Find HBs, the set of data structure instances hb (H,Bind1) such that demo (Bs), as in step 5 of this method, instantiates Bs.

3.3 Find H1s, the set of H1 such that there exists a Bind such that the data structure instance hb(Hi,Bind) is a member of HBs.

3.4 Find AXs, the set of data structure instances AX such that there exist H1, Bind1, HBs, H11, and B11s for which

3.4.1 a data structure instance hb (H1, Bind1) is a member of the set HBs, and

3.4.2 this tdemo algorithm, applied recursively to the Question [t([H11, Bind1|B11s], T1s)] yields an answer data structure instance AX.

3.5 Then the Answer is (t(H1s, [ ]),AXs].

4. If the Question is of the form [t([H, _|Bs], Ts)|T1s]

4.1 Find [t([_H1, Bind1|_{—B}1s], _)|_{—]=Ts}

4.2 Find HBs, the set of data structure instances hb (H, Bind1) such that demo (Bs), as in step 5 of this method, instantiates Bs.

4.3 Find T2s, the set of data structure instances T such that there exist Ts for which

4.3.1 a data structure instance hb (H₁, Bind1) is a member of the set HBs, and

4.3.2 this tdemo algorithm, applied recursively to the Question Ts yields an answer data structure instance T.

4.4 this tdemo algorithm, applied recursively to the Question T1s yields an answer data structure instance T11s.

4.5 Then the Answer is [t([H11], T2s)|T11s].

5. To demo (Bs), where Bs is in general a list of logical statements to be demonstrated to be True:

5.1 If Bs is the empty list, return True.

5.2 If Bs is a list of the form [B₁, B₂, . . . , Bₘ] in which each Bᵢ is a single logical statement, demo (B₁) by matching it a fact in a table, or by matching it to the conclusion of a rule and then demo the premises of the rule. If any of the variables of B₁ are bound to constant values during demo (B1), bind the corresponding occurrences of variables in [B₂, . . . , Bₘ] to those constant values, then demo ([B₂, . . . , Bₘ]).

5.3 If demo (Bᵢ) fails to find matching values, backtrack progressively to find new values in [Bᵢ₋₁, . . . B₁]. If such values are found, retry demo (Bᵢ).

5.4 If no (further) instance of [B₁, B₂, . . . , Bₘ] can be found, return False.

End of Method Answer-Master-Detail-Question

Given the table, the simple syllogism, and the master-detail syllogism of the Car example described above, the compilation of the master-detail syllogism into a data structure, together with the method Answer-Master-Detail-Question, can produce an answer data structure such as

[[t([p3(‘Car’)],

[[t([[‘Front Axle’]],

[[t([[‘Left CV Joint’],[‘Right CV Joint’]],[])]])],

[t([[‘Rear Axle’]],

[[t([[‘Left Rear Wheel’],[‘Right Rear Wheel’]],[])]])]])]]

that is suitable for mapping into an end user answer display such as the one shown in FIG. 2, or the one below.

Car

Front Axle

Left CV Joint
Right CV Joint

Rear Axle

Left Rear Wheel
Right Rear Wheel.

In general, it may not be clear to an end user how such an answer has been found, and which facts in the database support the answer. The present invention includes a method for explaining results from master-detail syllogisms. For example, if the user asks for an explanation of the entry Right Rear Wheel in the above answer, e.g. by selecting it using a radio button as shown in FIG. 2, then the method for explaining results can produce the following data structure.

[[t([[p3(‘Car’)]],

[[t([[‘Rear Axle’]],

[t([[‘Right Rear Wheel’]],[])])]])],

[p1(‘Car’,1,‘Rear Axle’),

p2(‘Car’,‘Rear Axle’)],

[p1(‘Rear Axle’,1,‘Right Rear Wheel’),

p2(‘Rear Axle’,‘Right Rear Wheel’)]]

The data structure shows that an instance of conclusion of the master-detail detail syllogism is logically supported by two instances of the other, plain syllogism. Each instance of the plain syllogism is in turn supported by facts in the table. It is straightforward to map such a data structure into an end user explanation page such as the one shown in FIG. 3. The method for explaining master-detail results is as follows.

Method Explain-Master-Detail-Result

INPUT: A master-detail Answer in logical data structure tree notation of the general form [t([H,_|Bs], Ts)|T1s], where Ts and T1s are (sub) Answers, together with an integer specifying which entry in the tree is to be explained.

OUTPUT: A subtree of the input, together with its logical derivation

1. Number the entries in the answer tree. For example, if the answer tree, when shown in indented format is

[[p3(‘Car’)]]

[[‘Front Axle’]]

[[‘Left CV Joint’],[‘Right CV Joint’]]

[[‘Rear Axle’]]

[[‘Left Rear Wheel’], [‘Right Rear Wheel’]]

then the numbered answer tree is

[1:[p3(‘Car’)]]

[2:[‘Front Axle’]]

[3:[‘Left CV Joint’],4:[‘Right CV Joint’]]

[5:[‘Rear Axle’]]

[6:[‘Left Rear Wheel’],7:[‘Right Rear Wheel’]]

2. Find the subtree of the numbered tree that traces a path from the root to the entry numbered with the integer specifying the entry to be explained. For example, if the numbered tree is as above, and the entry numbered 7 is to be explained, this step produces the numbered subtree

[1:[p3(‘Car’)]]

[5:[‘Rear Axle’]]

[7:[‘Right Rear Wheel’]]

3. Remove the numbers from the subtree. For example, if the numbered subtree is as above, this step produces

[[p3(‘Car’)]]

[[‘Rear Axle’]]

[[‘Right Rear Wheel’]]

4. Find the supporting logical derivation for the subtree. For example, if the rules used to find the answer tree are of the form

[t([p3(A), [ ],p1(A, B, C),p1(C, D, E)], . . . )]

and

[p1(A, 1, B),p2(A, B)]

then the supporting logical derivation is

[[p1(‘Car’, 1, ‘Rear Axle’),p2(‘Car’, ‘Rear Axle’)],

[p1(‘Rear Axle’, 1, ‘Right Rear Wheel’), p2(‘Rear Axle’, ‘Right Rear Wheel’)]]

5. Combine the subtree from step 3 with the supporting logical derivation from step 4 to get the logical form of the explanation. In the example used above, the logical form of the explanation is the data structure

[[t([[p3(‘Car’)]],

[[t([[‘Rear Axle’]],

[t([[‘Right Rear Wheel’]],[])])]])],

[p1(‘Car’,1,‘Rear Axle’),

p2(‘Car’,‘Rear Axle’)],

[p1(‘Rear Axle’,1,‘Right Rear Wheel’),

p2(‘Rear Axle’,‘Right Rear Wheel’)]]

End of Method Explain-Master-Detail-Result

This concludes the detailed description of the invention. The following describes some alternative embodiments for accomplishing the present invention. For example, any type of computer, such as a mainframe, minicomputer, or personal computer, or computer configuration, such as a timesharing mainframe, local area network, virtual private network, peer-to-peer network, or standalone personal computer, could be used with the present invention.

In summary, the present invention discloses a method, system, apparatus, and article of manufacture to support the highly declarative end user specification, execution, and explanation of master-detail applications of relational databases. The present invention goes beyond the prior art in that the master-detail applications that an end user can specify are no longer limited by intermediate logic that a DBA has implemented, and that a DBA must maintain.

The present invention also goes beyond the prior art in that the master-detail applications that an end user can specify are no longer limited by code that application programmers have implemented, and that application programmers must maintain. The present invention also goes beyond the prior art in that the results from master-detail applications that an end user can specify can be automatically explained, as logically following from the syllogisms and from the supporting facts in the database.

The foregoing description of the preferred embodiment of the invention has been presented for the purposes of illustration and description. It is not intended to be exhaustive or to limit the invention to the precise form disclosed. Many modifications and variations are possible in light of the above teaching. For example, questions put to a system containing a master-detail syllogisms could originate from other applications and could be phrased in the notation known as XML. Likewise, answers and explanations can easily be phrased in XML and passed to further applications, e.g. for display in customized forms in Web pages. Similarly, one skilled in the art will recognize that many of the computations described above can easily be compiled, for efficient execution, into the database access and manipulation language SQL. It is intended that the scope of the invention be limited not by this detailed description, but rather by the claims appended hereto.

What I claim as my invention is:

1. A computer-implemented method and system to allow an end user, who need not be trained as a database administrator or as an application programmer, to write a highly declarative specification of a master-detail application of a relational database, using sentences containing his own natural language words and phrases and place-holders, to directly run the specification as though it were a program, and to directly and automatically obtain explanations of the results.

2. The method of claim 1, further comprising a notation in which an end user can specify an application over a database using his own natural-language words and phrases in syllogisms containing place holders, including master-detail syllogisms containing indented conclusion lines, and in which an end user can write tables of data with heading lines containing his own natural-language words and phrases and place holders.

3. The method of claim 1, further comprising a step in which the method and system maintain a correspondence between (a) a sentence containing one or more place-holders, the sentence having been written by the end user using natural language words and phrases of his own choosing, and (b) an internal notation consisting of a logical predicate in which variables correspond respectively to the place holders, and in which the predicate name corresponds to the rest of the sentence; the correspondence being maintained automatically by the method without necessarily requiring the separate maintenance of any natural language dictionary or grammar.

4. The method of claim 1, further comprising a step in which a master-detail syllogism is compiled into a hierarchical data structure containing variables.

5. The method of claim 1, further comprising a method of directly executing a highly declarative specification of a master-detail application of a relational database, such that an answer to an input question is a master-detail hierarchy that logically follows from the specification and the database.

6. The method of claim 1, further comprising a method of directly and automatically providing explanations of results obtained from highly declarative end user specifications of master-detail applications of relational databases.

7. The method of claim 1, further comprising steps such that, the range of applications that an end user can specify is not limited by a logical schema that must be pre-written, and maintained, by a Database Administrator.

8. The method of claim 1, further comprising steps such that the range of applications that an end user can specify is not limited by components that must be written and maintained by an application programmer.

9. The method of claim 1, further comprising steps such that, parts or all of the direct execution method for, and of the direct explanation method for, a highly declarative end user specification of a master-detail application of relational databases, are automatically compiled, for efficiency, into the database access language SQL.

10. The method of claim 1, further comprising steps such that, the input master-detail and other information is made available to the direct execution method, and to the direct explanation method, in the notation known as XML, or in the notation known as HTML, or in other similar tagged notation.

11. The method of claim 1, further comprising steps such that, the input table information is made available to the direct execution method, and to the direct explanation method, in the notation known as XML, or in the notation known as HTML, or in other similar tagged notation.

12. The method of claim 1, further comprising steps such that, the output master-detail and other information is made available from the direct execution method, and from the direct explanation method, in the notation known as XML, or in the notation known as HTML, or in other similar tagged notation.

13. The method of claim 1, further comprising steps such that, the output master-detail and other information is made available from the direct execution method, and from the direct explanation method, in end user readable displays containing nested master-detail tables.
